(19) United States
(12) Patent Application Publication
(10) Pub. No.: US 2020/0191971 A1
(43) Pub. Date: Jun. 18, 2020

(54) Method and System for Vehicle Detection Using LIDAR

(71) Applicant: National Chung-Shan Institute of Science and Technology, Taoyuan City (TW)

(72) Inventors: Kai-Lung Hua, Taipei City (TW); Shih-Che Chien, Hsinchu City (TW); Feng-Chia Chang, Taoyuan City (TW); Ding-Wei Zhuang, Taoyuan City (TW); Yu-Sung Hsiao, Taoyuan City (TW); Chien-Hao Hsiao, Hsinchu City (TW)

(21) Appl. No.: 16/223,068

(22) Filed: Dec. 17, 2018

(51) Int. Cl. G01S 17/93; G01S 17/89; G06K 9/00; G06T 7/174; G06T 7/593

(52) U.S. Cl. CPC G01S 17/936; G01S 17/89; G06K 9/00201; G06T 2207/20084; G06T 7/593; G06T 2207/10028; G06T 7/174

(57) ABSTRACT

A vehicle detection method includes acquiring a three-dimensional (3D) image with a plurality of point clouds; mapping the 3D image onto a two-dimensional (2D) image; interpolating the 2D image according to a distance between a camera and a first point cloud of the plurality of point clouds; transforming the 3D image into a plurality of voxels, and extracting a plurality of 3D deep features and a plurality of 2D deep features according to the plurality of voxels; and determining a detection result according to a classification of the plurality of 3D deep features and the plurality of 2D deep features.

### BACKGROUND OF THE INVENTION

### 1. Field of the Invention

The present disclosure relates to a method and system for vehicle detection method, and more particularly, to a method and system capable of detecting vehicles with a light detection and ranging system.

### 2. Description of the Prior Art

Light detection and ranging (LIDAR) system is one of important elements in automatic driving system, which is utilized for detecting vehicles and pedestrians. The LIDAR system emits electromagnetic radiation to detect distances with objects and generate point clouds corresponding to the objects. Compared with millimeter wave (MMW) radars, the LIDAR system has higher resolution rate for space and higher ranging accuracy, and a detection range of the LIDAR system is around 50 meter. However, when the object is further, the point clouds detected by the LIDAR system are sparser and hard to recognize. In addition, the conventional image-based method, which utilizes the LIDAR system to detect objects, cannot provide clear images when in harsh environments, such as night, rainy or foggy days. Therefore, the disadvantages stated above of the prior art should be improved.

### SUMMARY OF THE INVENTION

The present disclosure provides a method and system for vehicle detection method to detect the vehicles with LIDAR system and improve the accuracy of vehicle detection.

An embodiment of the present disclosure discloses a vehicle detection method, comprising acquiring a three-dimensional (3D) image with a plurality of point clouds; mapping the 3D image onto a two-dimensional (2D) image; interpolating the 2D image according to a distance between a camera and a first point cloud of the plurality of point clouds; transforming the 3D image into a plurality of voxels, and extracting a plurality of 3D deep features and a plurality of 2D deep features according to the plurality of voxels; and determining a detection result according to a classification of the plurality of 3D deep features and the plurality of 2D deep features.

Another embodiment of the present disclosure discloses a computer system, comprising a processing device; and a memory device coupled to the processing device, for storing a program code instructing the processing device to perform a process of vehicle detection method, wherein the process comprises acquiring a three-dimensional (3D) image with a plurality of point clouds; mapping the 3D image onto a two-dimensional (2D) image; interpolating the 2D image according to a distance between a camera and a first point cloud of the plurality of point clouds; transforming the 3D image into a plurality of voxels, extracting a plurality of 3D deep features and a plurality of 2D deep features according to the plurality of voxels; and determining a detection result according to a classification of the plurality of 3D deep features and the plurality of 2D deep features.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a vehicle detection process according to an embodiment of the present disclosure.

FIG. 2 is a schematic diagram of an interpolation of a 2D image according to an embodiment of the present disclosure.

FIG. 3 is a schematic diagram of a 3D convolutional neural network according to an embodiment of the present disclosure.

FIG. 4 is a schematic diagram of a computer system according to an example of the present disclosure.

### DETAILED DESCRIPTION

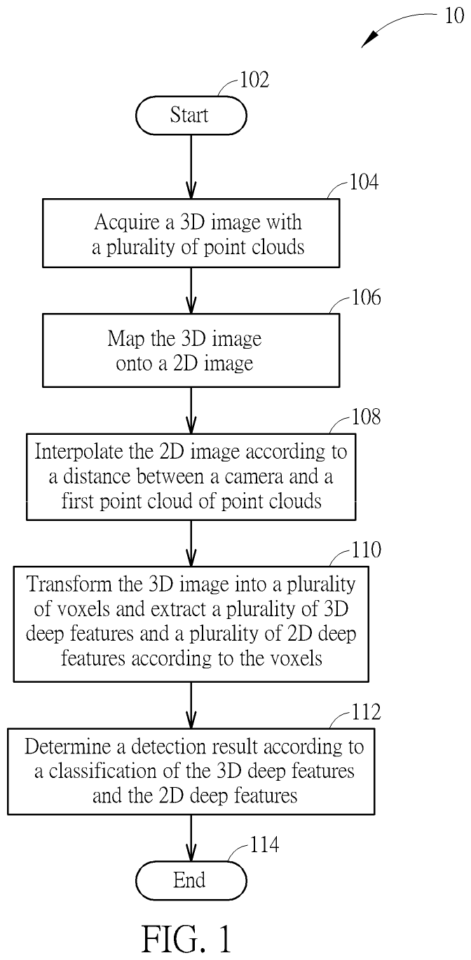

Please refer to FIG. 1, which is a schematic diagram of avehicle detection process 10 according to an embodiment of the present disclosure. The vehicle detection process 10 includes the following steps:

Step 102: Start.

Step 104: Acquire a three-dimensional (3D) image with a plurality of point clouds.

Step 106: Map the 3D image onto a two-dimensional (2D) image.

Step 108: Interpolate the 2D image according to a distance between a camera and a first point cloud of point clouds.

Step 110: Transform the 3D image into a plurality of voxels and extract a plurality of 3D deep features and a plurality of 2D deep features according to the voxels.

Step 112: Determine a detection result according to a classification of the 3D deep features and the 2D deep features.

Step 114: End.

According to the vehicle detection process 10, in step 104, the 3D image with point clouds is acquired. The point clouds in the 3D image may represent a plurality of objects. In an embodiment, the 3D image may be obtained by a light detection and ranging (LIDAR) system and normalized in XYZ axes. After the 3D image is acquired, a ground removal for the 3D image is utilized for removing the ground in the 3D image with a random sample consensus (RANSAC) method or device. Before determining the objects from the point clouds, the point clouds of the 3D image may be filtered into a plurality of object-candidate point clouds according to distances between each point. More specifically, the object-candidate point clouds are filtered by a K-D tree search method, which clusters the point clouds based on distances between each point. In an example, when a distance between two points is less than 0.2 meter, the K-D tree search method clusters the two points as a group, and filters the groups based on a dimension, e.g. length, width and height, into the object-candidate point cloud. Therefore, a preliminary filtering of the object-candidate point cloud of the vehicle detection is determined.

The vehicle detection process 10 further extracts traditional feature vectors and depth features from the filtered object-candidate point clouds for calculation and evaluation, and classifies the object-candidate point clouds based on a machine learning method, so as to determine whether the object-candidate point clouds belongs to a vehicle or not.

To improve the accuracy of the classification and determination of vehicle detection, in step 106, the vehicle detection method maps the 3D image onto a two-dimensional image. In an embodiment, since the vehicle is not certainly right in front of a shooting place, a camera or a user, the 3D image is rotated according to an angle and a distance between a camera and a first point cloud of the object-candidate point clouds and is mapped onto the 2D image by flattening.

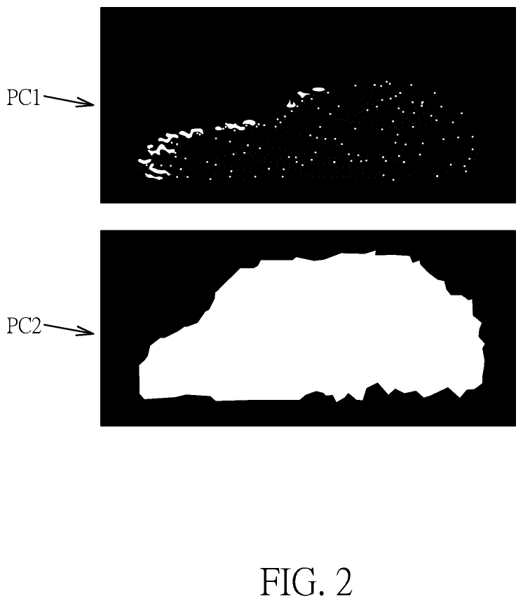

In addition, when the distance between the vehicle and the shooting place, camera or user is too long, the generated point clouds of the 3D image are sparse. Thus, in step 108, the vehicle detection method 10 interpolates the 2D image generated in step 106 according to the distance between a camera and the point cloud. In an embodiment, the sparser of the point cloud of the 2D image, the more points to be interpolated thereon. As shown in FIG. 2, which is a schematic diagram of an interpolation of the 2D image according to an embodiment of the present disclosure, a point clouds PC1 is too sparse to be recognized for the vehicle detection, and a point clouds PC2 is generated based on step 108. Notably, before interpolating the point cloud of the 2D image, a contour of the point clouds is determined, and relative 2D features may be extracted by histogram of oriented gradient (HOG), local binary patterns (LBP) or Haar-like method.

In order to further improve the accuracy of the vehicle detection, in step 110, the 3D image is transformed into voxels and the 3D deep features of the voxels are extracted. In other words, the 3D image is voxelized. In an embodiment, the contour of the object-candidate point clouds is divided into N*N*N blocks, a total amount of points in each block is calculated and each block is then normalized between 0 and 1 as the voxels. In an embodiment, the 3D deep features are extracted by a 3D convolutional neural network and the 2D deep features are extracted by a 2D neural network.

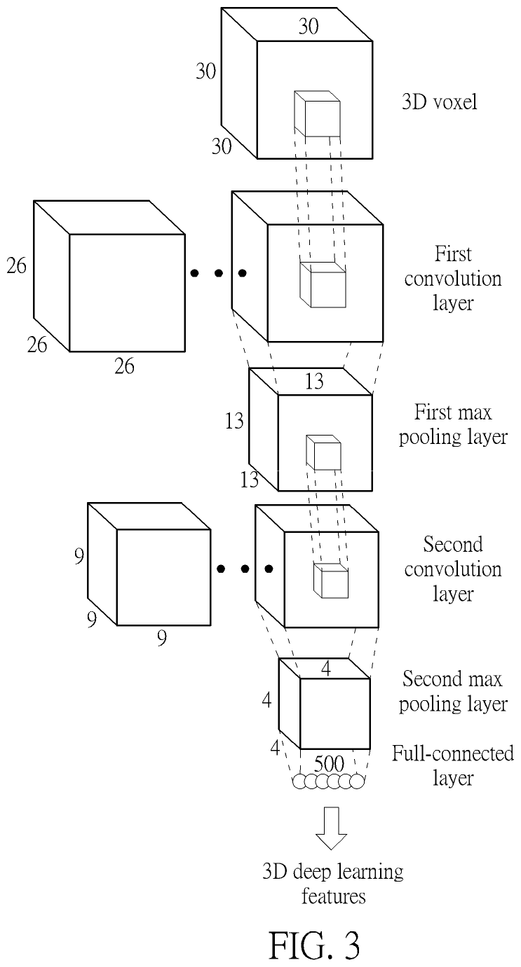

Referring to FIG. 3, which is a schematic diagram of a 3D convolutional neural network according to an embodiment of the present disclosure. In an experimental example, when N is 30, and an input layer of the 3D convolutional neural network is the voxel with a dimension of 30*30*30, a kernel quantity of a convolutional layer of the 3D convolutional neural network is 30*30 with a kernel size of 5*5*5. The voxel size of a first convolution layer, a first max pooling layer, a second convolutional layer, a second max pooling and a fully connected layer are respectively 26*26*26, 13*13*13, 9*9*9, 4*4*4 and 500. That is, the 500 features generated by the fully connected layer are utilized for the 3D deep learning features of the 3D convolutional neural network.

The neural network decomposes the 2D deep features and the 3D deep features into a deep convolution process and a pointwise convolution process after extracting the 2D deep features and 3D deep features from the 2D image and the 3D image. The decomposition of the neural network significantly decreases calculations and parameters involved. The deep convolution process is to individually convolute each channel of an image (e.g. RGB channels of the image) and reduce the image size, where a channel number of the image remains unchanged (i.e. three channels before and after the deep convolution). The poinwise convolution is to convolute each points of the image by setting the kernel number of the convolution to change the channels after the convolution without changing the image size. Consequently, the operation of the deep convolution process and the pointwise convolution process simplifies the calculations and parameters involved.

With the determined and extracted 3D features, 2D features and deep features, in step 112, a detection result of the image may be determined according to a classification of the 3D deep features and the 2D deep features. In an embodiment, the detection result may be made by a classification of machine learning.

Therefore, the vehicle detection method 10 of the present disclosure significantly reduces complexity and calculation of the transformation and detects the vehicle more precisely and accurately with abundant traditional features and the deep features of object-candidate point clouds, such that the vehicle detection method 10 may be further utilized on automatic driving system or relative industry.

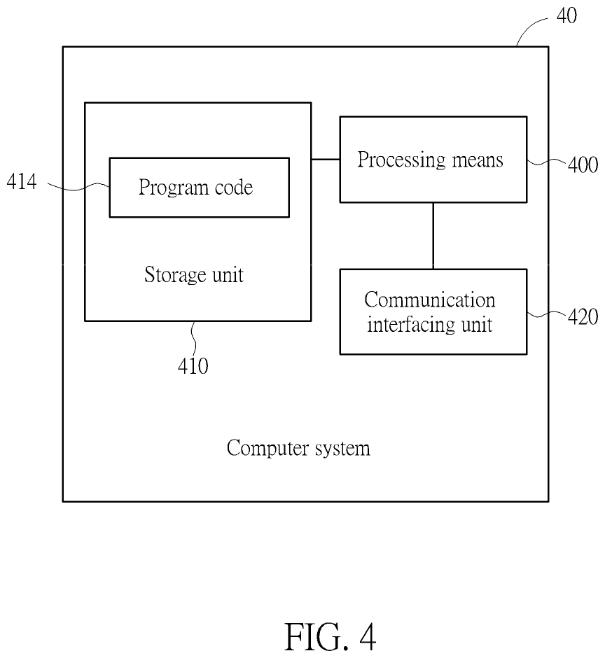

Moreover, the vehicle detection method 10 of the present disclosure may be implemented in all kinds of ways, please refer to FIG. 4, which is a schematic diagram of a computer system 40 according to an example of the present invention. The computer system 40 may include a processing means 400 such as a microprocessor or Application Specific Integrated Circuit (ASIC), a storage unit 410 and a communication interfacing unit 420. The storage unit 410 may be any data storage device that can store a program code 414, accessed and executed by the processing means 400. Examples of the storage unit 410 include but are not limited to a subscriber identity module (SIM), read-only memory (ROM), flash memory, random-access memory (RAM), CD-ROM/DVD-ROM, magnetic tape, hard disk and optical data storage device.

Notably, the embodiments stated above illustrates the concept of the present invention, those skilled in the art may make proper modifications accordingly, and not limited thereto. For example, the camera for taking the images may be implemented by a RGB-camera to optimize the system, or the deep features may be determined by other relative methods, and not limited thereto.

In summary, the vehicle detection method and system of the present disclosure utilize the LIDAR system and extract the deep features by the neural network, such that the accuracy of vehicle detection is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicle detection method, comprising:
acquiring a three-dimensional (3D) image with a plurality of point clouds;
mapping the 3D image onto a two-dimensional (2D) image;
interpolating the 2D image according to a distance between a camera and a first point cloud of the plurality of point clouds;
transforming the 3D image into a plurality of voxels, and extracting a plurality of 3D deep features and a plurality of 2D deep features according to the plurality of voxels; and
determining a detection result according to a classification of the plurality of 3D deep features and the plurality of 2D deep features.

2. The vehicle detection method of claim 1, further comprising:
performing a ground removal for the 3D image after acquiring the 3D image; and
filtering the plurality of point clouds into a plurality of object-candidate point clouds.

3. The vehicle detection method of claim 2, wherein the ground removal is performed by a random sample consensus (RANSAC) method.

4. The vehicle detection method of claim 2, wherein the plurality of object-candidate point clouds are filtered by a K-D tree search method.

5. The vehicle detection method of claim 1, wherein the 3D image is acquired by a light detection and ranging (LIDAR) and the 3D data is normalized.

6. The vehicle detection method of claim 1, wherein the 3D image is rotated according to an angle between the camera and the first point cloud and is mapped onto the 2D image by flattening.

7. The vehicle detection method of claim 1, wherein the 2D image is interpolated according to the distance.

8. The vehicle detection method of claim 1, wherein the plurality of 3D deep features are extracted by a 3D convolutional neural network and the plurality of 2D deep features are extracted by a 2D neural network.

9. The vehicle detection method of claim 1, wherein an input layer of the 3D convolutional neural network is a voxel with a dimension of 30*30*30, and a kernel quantity of a convolutional layer of the 3D convolutional neural network is 30*30 with a kernel size of 5*5*5.

10. A computer system, comprising:
a processing device; and
a memory device coupled to the processing device, for storing a program code instructing the processing device to perform a process of vehicle detection method, wherein the process comprises:
acquiring a three-dimensional (3D) image with a plurality of point clouds;
mapping the 3D image onto a two-dimensional (2D) image;
interpolating the 2D image according to a distance between a camera and a first point cloud of the plurality of point clouds;
transforming the 3D image into a plurality of voxels, extracting a plurality of 3D deep features and a plurality of 2D deep features according to the plurality of voxels; and
determining a detection result according to a classification of the plurality of 3D deep features and the plurality of 2D deep features.

11. The computer system of claim 10, wherein the process further comprises:
performing a ground removal for the 3D image after acquiring the 3D image; and
filtering the plurality of point clouds into a plurality of object-candidate point clouds.

12. The computer system of claim 11, wherein the ground removal is performed by a random sample consensus method.

13. The computer system of claim 11, wherein the plurality of object-candidate point clouds are filtered by a K-D tree search method.

14. The computer system of claim 10, wherein the 3D image is acquired by a light detection and ranging (LIDAR) and the 3D image is normalized.

15. The computer system of claim 10, wherein the 3D image is rotated according to an angle between the camera and the first point cloud and is mapped onto the 2D image by flattening.

16. The computer system of claim 10, wherein the 2D image is interpolated according to the distance.

17. The computer system of claim 10, wherein the plurality of 3D deep features are extracted by a 3D convolutional neural network and the plurality of 2D deep features are extracted by a 2D neural network.

18. The computer system of claim 10, wherein an input layer of the 3D convolutional neural network is a voxel with a dimension of 30*30*30, and a kernel quantity of a convolutional layer of the 3D convolutional neural network is 30*30 with a kernel size of 5*5*5.
